(19) United States
(12) Patent Application Publication
(10) Pub. No.: US 2020/0245223 A1
(43) Pub. Date: Jul. 30, 2020

(54) PACKET ROUTING METHOD AND COMMUNICATION SYSTEM

(71) Applicant: Industrial Technology Research Institute, Hsinchu (TW)

(72) Inventors: Ching-Wen Cheng, Tainan City (TW); Chun-Yuan Chiu, Pingtung County (TW)

(73) Assignee: Industrial Technology Research Institute, Hsinchu (TW)

(21) Appl. No.: 16/727,933

(22) Filed: Dec. 27, 2019

Related U.S. Application Data
(60) Provisional application No. 62/796,591, filed on Jan. 25, 2019.

(51) Int. Cl. H04W 40/36; H04L 12/741; H04W 40/12; H04W 36/00

(52) U.S. Cl. CPC H04W 40/36; H04W 36/0072; H04W 40/12; H04L 45/745

(57) ABSTRACT

A packet routing method is provided according to an embodiment. The method includes: updating a first routing configuration configured to a source node and a second routing configuration configured to a target node in response to a handover of a user equipment (UE) from the source node to the target node; receiving a first packet with a first header reflecting a result of the handover; and transmitting the first packet with the first header according to at least one of the updated first routing configuration and the updated second routing configuration.

### CROSS-REFERENCE TO RELATED APPLICATION

This application claims the priority benefit of U.S. provisional application Ser. No. 62/796,591, filed on Jan. 25, 2019. The entirety of the above-mentioned patent application is hereby incorporated by reference herein and made a part of this specification.

### TECHNICAL FIELD

This disclosure is directed to a packet routing method for handling a handover of a user equipment (UE) from a source node to a target node and a communication system.

### BACKGROUND

FIG. 1 is a schematic diagram of an Integrated Access and Backhaul (IAB) architecture. Referring to FIG. 1, the IAB architecture comprises at least one IAB-donor and multiple IAB-nodes (e.g., IAB-node1 to IAB-node4). The IAB-donor connects with the Core Network (CN) and can serve one or more UEs and the IAB-nodes. The IAB-nodes have wireless backhauling capability and can serve the one or more UEs and other IAB-nodes. The CU (Central Unit) at the IAB-donor holds the control and upper layer functionalities. For example, Radio Resource Control (RRC), Service Date Adaption Protocol (SDAP) and Packet Data Convergence Protocol (PDCP) layers are reside in the CU. The Distributed Units (DUs) at the IAB-donor and the IAB-nodes provide access connections to the UE and the downstream Mobile Termination (MT) of the other IAB-nodes. For example, Radio Link Control (RLC), Medium Access Control (MAC) and Physical (PHY) layers are hosted by the DUs. Furthermore, a Backhaul Adaptation Protocol (BAP) layer, which is an adaptation layer, is associated with the RLC. The BAP layer is configured to route data packet across the IAB network topology.

In some cases, a handover of the UE from a source node (e.g., the IAB-node2) to a target node (e.g., the IAB-node4) occurs to change the connection paths between the UE and the CU. How to perform the packet routing when said handover occurs would be an issue to be solved.

### SUMMARY

Accordingly, the disclosure is directed to a packet routing method for handling a handover of a user equipment (UE) from a source node to a target node and a communication system.

A packet routing method for at least one node in a communication system is provided according to an embodiment. The method includes: updating, by a control node, a first routing configuration configured to a source node and a second routing configuration configured to a target node in response to a handover of a user equipment (UE) from the source node to the target node; receiving, by at least one of the source node and the target node, a first packet with a first header reflecting a result of the handover; and transmitting, by the at least one of the source node and the target node, the first packet with the first header according to at least one of the updated first routing configuration and the updated second routing configuration.

A communication system comprising a UE, a source node, a target node and a control node is provided according to an embodiment. The control node is coupled to the source node and the target node and configured to update a first routing configuration configured to the source node and a second routing configuration configured to the target node in response to a handover of a UE from the source node to the target node. At least one of the source node and the target node is configured to receive a first packet with a first header reflecting a result of the handover. The at least one of the source node and the target node is further configured to transmit the first packet with the first header according to at least one of the updated first routing configuration and the updated second routing configuration.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an Integrated Access and Backhaul (IAB) architecture.

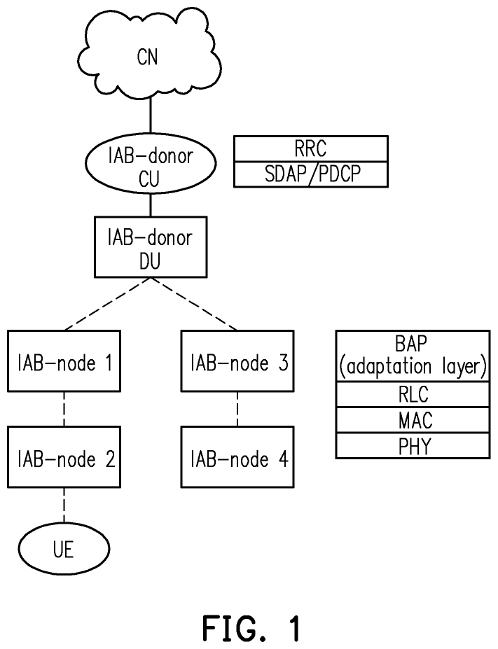

FIG. 2 is a schematic diagram of packet routing according to an embodiment of the disclosure.

FIG. 3 is a schematic diagram of a handover of a UE from a first node to a second node according to an embodiment of the disclosure.

FIG. 4 is a schematic diagram of a packet routing in response to a handover according to an embodiment of the disclosure.

FIG. 5 is a schematic diagram of a packet routing in response to a handover according to an embodiment of the disclosure.

FIG. 6 is a schematic diagram of a packet routing in response to a handover according to an embodiment of the disclosure.

FIG. 7 is a schematic diagram of a handover of a UE from a first node to a second node according to an embodiment of the disclosure.

FIG. 8 is a schematic diagram of a packet routing in response to a handover according to an embodiment of the disclosure.

FIG. 9 is a schematic diagram of a packet routing in response to a handover according to an embodiment of the disclosure.

FIG. 10 is a schematic diagram of a handover of a UE from a first node to a second node according to an embodiment of the disclosure.

FIG. 11 is a communication time flow according to an embodiment of the disclosure.

FIG. 12 is a flowchart of a packet routing method according to an embodiment of the disclosure.

FIG. 13 is a flowchart of a packet routing method according to an embodiment of the disclosure.

FIG. 14 is a flowchart of a packet routing method according to an embodiment of the disclosure.

FIG. 15 is a flowchart of a packet routing method according to an embodiment of the disclosure.

FIG. 16 is a flowchart of a packet routing method according to an embodiment of the disclosure.

FIG. 17 is a flowchart of a packet routing method according to an embodiment of the disclosure.

FIG. 18 is a schematic diagram of a packet routing with a delayed RLC ack according to an embodiment of the disclosure.

### DESCRIPTION OF THE EMBODIMENTS

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

Reference will now be made in detail to the embodiments of the disclosure, examples of which are illustrated in the accompanying drawings. Wherever possible, the same reference numbers are used in the drawings and the description to refer to the same or like parts.

The term “node” in this disclosure could be synonymous, for example, with a variation or a sub-variation of a cell, a serving cell, a “gNodeB” (gNB), an “eNodeB” (eNB), a Node-B, a base station (BS), an advanced BS (ABS), a transmission reception point (TRP), an unlicensed cell, an unlicensed serving cell, an unlicensed TRP, a base transceiver system (BTS), an access point, a home BS, a relay station, a scatterer, a repeater, an intermediate node, an intermediary, satellite-based communication BSs, and so forth.

The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and the like. In some applications, a UE may be a fixed computer device operating in a mobile environment, such as a bus, a train, an airplane, a boat, a car, and so forth.

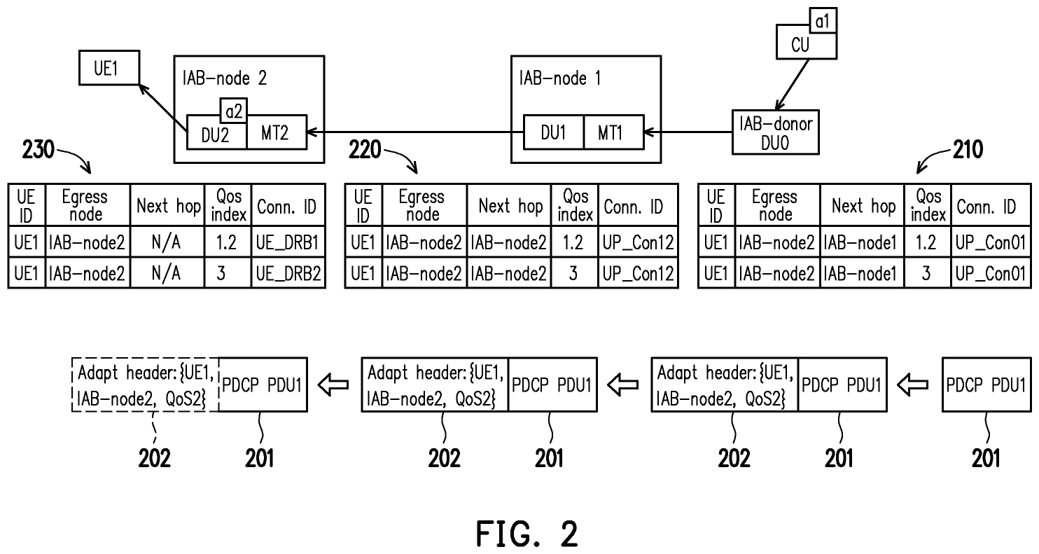

FIG. 2 is a schematic diagram of packet routing according to an embodiment of the disclosure. Referring to FIG. 2, in a communication system with an IAB network structure, an IAB-donor CU (also referred to as a control node) sends a packet a1 to an UE1 through the routing of an IAB-donor DU0, an IAB-node1 and an IAB-node2. For example, during the routing of the packet a1, the IAB-node1 may receive the packet a1 from the IAB-donor CU by an interface of MT1 and then transmit the packet a1 by an interface of DU1, and the IAB-node2 may receive the packet a1 from the IAB-node1 by an interface of MT2 and then transmit the packet a1 to the UE1 by an interface of DU2.

In an embodiment, the IAB-donor CU may send instructions to the IAB-donor DU0, the IAB-node1 and the IAB-node2 for configuring routing configurations 210 to 230 to the IAB-donor DU0, the IAB-node1 and the IAB-node2, respectively. In other words, the routing configurations 210 to 230 are stored in the IAB-donor DU0, the IAB-node1 and the IAB-node2, respectively. The IAB-donor DU0, the IAB-node1 and the IAB-node2 may route the packet a1 to the UE1 according to the configured routing configurations 210 to 230, respectively.

In an embodiment, the routing configurations 210 to 230 record identification information of a UE associated with the packet a1, identification information of an egress node of the packet a1, identification information of a next hop for routing the packet a1, Quality of Service (QoS)/priority information of the packet a1 and identification information of a backhaul Radio Link Control (RLC) channel for transmitting the packet a1. However, in an embodiment, at least one of the routing configurations 210 to 230 may not record the identification information of the UE and/or the identification information of the next hop.

In an embodiment of FIG. 2, the identification information of the UE associated with the packet a1 includes identification information of the UE1 which is a routing destination of the packet a1, and the egress node of the packet a1 is the IAB-node1 which is an egress node (also referred to as a destination IAB-node) prior to the UE1. Furthermore, for the IAB-donor DU0, the next hop for routing the packet a1 is the IAB-node1; for the IAB-node1, the next hop for routing the packet a1 is the IAB-node2; and for the IAB-node2, the next hop for routing the packet a1 is none because there is no extra hop (i.e., IAB-node) between the IAB-node2 and the UE.

In an embodiment of FIG. 2, the QoS/priority information of the packet a1 is presented as QoS index 1 to 3, and the identification information of the RLC channel is presented as one or more connection IDs, such as UP_Con01, UP_Con12, UE_DRB1 and/or UE_DRB2. Each connection ID corresponds to one RLC channel or backhaul RLC channel.

In an embodiment of FIG. 2, the packet a1 includes a PDCP protocol data unit (PDU) (marked as PDCP PDU1) 201 and is sent with an adapt header (also referred to as an adaption header) 202 which is a header of an adaptation layer. The adapt header 202 carries routing information for IAB-donor DU (e.g., the IAB-donor DU0) and IAB-nodes (e.g., the IAB-node1 and the IAB-node2). In an embodiment, the adapt header 202 may be removed and the packet a1 may be transmitted to the UE1 when the packet a1 arrives the egress node (e.g., the IAB-node2) of the packet a1.

In an embodiment, the adapt header 202 carries information including identification information of a UE (e.g., UE1) associated with the packet a1, identification information of an egress node (e.g., the IAB-node2) of the packet a1 and QoS/priority information (e.g., QoS2) of the packet a1. However, in an embodiment, the adapt header 202 may not carry the identification information of the UE (e.g., UE1). The adapt header 202 may be packaged onto the packet a1 (or the PDCP PDU1 201). The IAB-donor DU0, the IAB-node1 and the IAB-node2 may route the packet a1 according to the adapt header 202 and the configured routing configurations 210 to 230, respectively.

In an embodiment, the IAB-donor CU may control a handover (also referred to as a mobility) of the UE1 from a first node (also referred to as a source node) to a second node (also referred to as a target node). A connection path between the UE1 and the IAB-donor CU is changed in response to the handover. In an embodiment, the IAB-donor CU may instruct updating of the routing configurations previously configured to the IAB donor DU and the IAB-nodes in response to the handover. In an embodiment, the IAB-donor CU may modify the adapt header of a packet to be sent to the UE1 in response to the handover. Modify may include release the old version and replaced with the latest version. For example, the IAB-donor CU may update the identification information of the “egress node” contained in the adapt header of a packet from the first node (i.e., the source node) to the second node (i.e., the target node) after the handover occurs. The updated routing configuration and the modified adapt header may both reflect a result of the handover or a new routing rule in response to the handover. According to the modified adapt header and the updated routing configuration, the packet may be correctly routed and transmitted to the UE1 based on the new routing rule after the handover occurs.

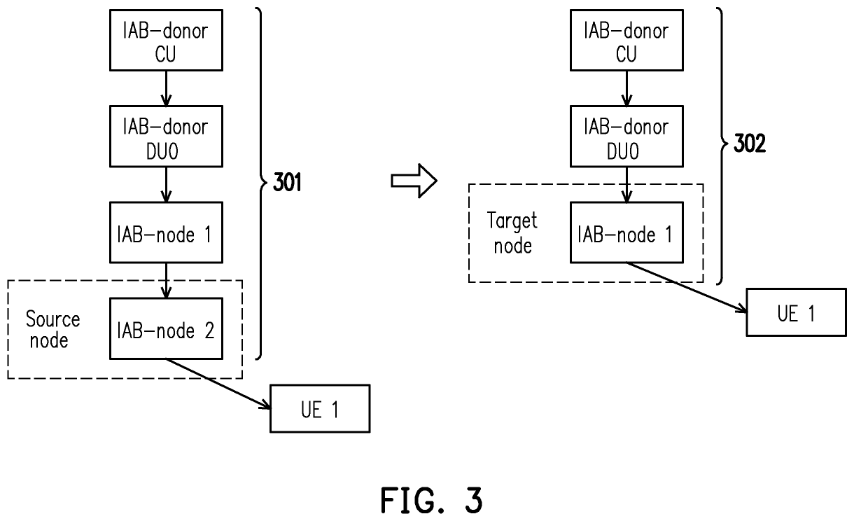

FIG. 3 is a schematic diagram of a handover of a UE from a first node to a second node according to an embodiment of the disclosure. Referring to FIG. 3, in an embodiment, a handover of the UE1 from the source node (e.g., the IAB-node2) to the target node (e.g., the IAB-node1) is occurred. In response to the handover, the connection path between the IAB-donor CU and the UE1 is changed from a connection path 301 to a connection path 302.

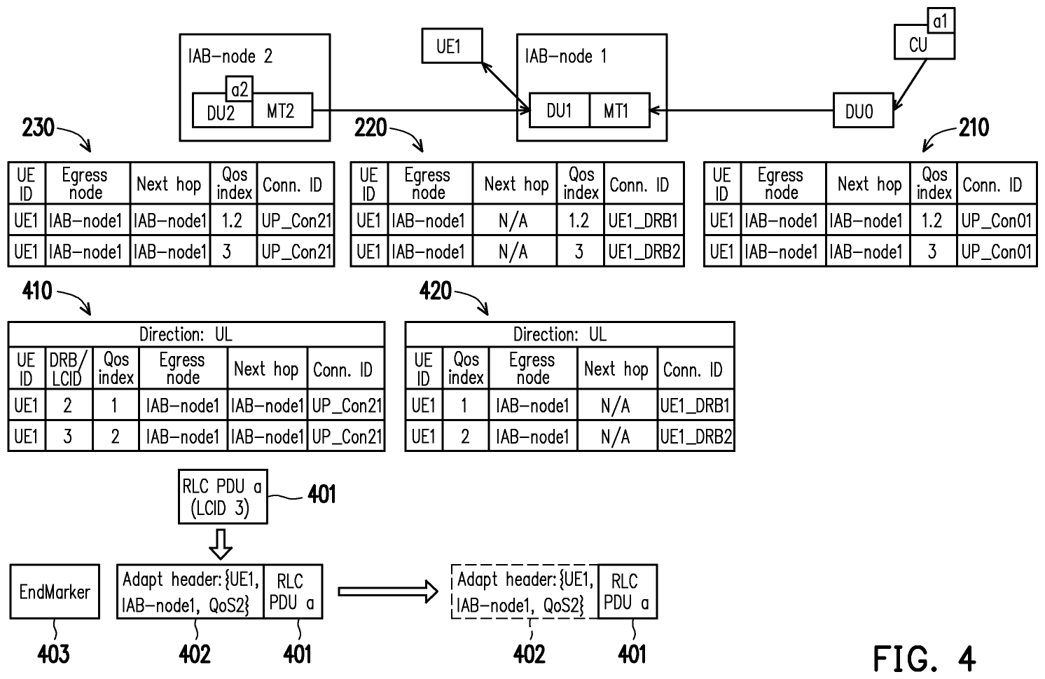

FIG. 4 is a schematic diagram of a packet routing in response to a handover according to an embodiment of the disclosure. Referring to FIG. 4, in response to the handover as shown in FIG. 3, the IAB-donor CU may send requests to the IAB-donor DU0, the IAB-node1 and the IAB-node2 to instruct updating of the routing configurations 210 to 230, respectively. The content of the updated routing configurations 210 to 230 is shown in FIG. 4 as example. For example, in the updated routing configurations 210 to 230, the egress node is all updated to be the “IAB-node1” to reflect a result of the handover. For example, the next hop recorded in the routing configuration 220 is updated to be “N/A”, which indicates that the “IAB-node1” is the new egress node of the packet a1 (i.e., the destination IAB-node).

In an embodiment of FIG. 4, after the handover as shown in FIG. 3 occurs, the packet a1 to be delivered to the UE1 may be sent with an adapt header which carries information including identification information of the “egress node” being the “IAB-node1”. Accordingly, the adapt header sent with the packet a1 may actually reflect the result of the handover (e.g., the egress node of the packet a1 is changed from the “IAB-node2” to the “IAB-node1”). In this case, the packet a1 with the adapt header may be routed to the UE1 according to the updated routing configurations 210 to 230 (or the updated routing configurations 210 and 220). For example, the IAB-donor DU0 may receive and transmit the packet a1 to the IAB-node1 according to the updated routing configuration 210, and then the IAB-node1 may receive and transmit the packet a1 to the UE1 according to the updated routing configuration 220.

However, in an embodiment, if a packet is sent before the handover occurs and the handover occurs during routing of this packet, then the old adapt header of this packet may not carry the latest routing information corresponding to the handover. Therefore, when an IAB-node handles this packet with the old adapt header according to the updated routing configuration, the information recorded in the old adapt header and the updated routing configuration may not be matched with each other. In this case, this packet may be dropped and the packet may be transmitted again from the IAB-donor CU, thereby increasing the transmission latency.

For example, in an embodiment of FIG. 4, if a packet a2 is sent from the IAB-donor CU to the UE1 before the handover as shown in occurs, then when the packet a2 arrives the IAB-node2, the adapt header of the packet a2 may be removed and the unacknowledged packet a2 may be buffered in the IAB-node2. Then, if the packet a2 is obtained from a buffer of the IAB-node2 and to be delivered to the UE1 after the handover occurs, the packet a2 may not has the correct adapt header for routing. In this case, the buffered packet a2 may not be able to be transmitted to the UE1 according to the updated routing configurations 210 to 230.

Accordingly, in an embodiment of FIG. 4, the IAB-donor CU may additionally configure temporary routing configuration (also known as adaptive routing configuration) to at least one of the first node (e.g., the IAB-node2) and the second node (e.g., the IAB-node1) in response to the handover. If a packet (e.g., the packet a2) is obtained without the header correctly reflecting the result of the handover, this packet may be routed and transmitted according to the temporary routing configuration. For example, the IAB-donor CU may configure a temporary routing configuration 410 to the IAB-node2 (which is the old destination IAB-node before handover occurs) and a temporary routing configuration 420 to the IAB-node1 (which is the new destination IAB-node after handover occurs). The temporary routing configurations 410 and 420 are both for uplink. The content of the temporary routing configurations 410 and 420 is shown in FIG. 4 as example. The packet a2 includes a RLC PDU a 401.

After the packet a2 without an adapt header is obtained of the buffer, the IAB-node2 may generate a new adapt header 402 according to the temporary routing configuration 410. For example, the IAB-node2 may obtain a logical channel identity (e.g., LCID 3) of the packet a2 and obtain matched routing information recorded in the temporary routing configuration 410 according to the logical channel identity. The obtained routing information may be added to the adapt header 402 and the adapt header 402 may reflect the result of the handover. The adapt header 402 may carry information as shown in FIG. 4 (e.g., UE1, IAB-node1 and Qos2) as example. Then, the adapt header 402 may be packaged onto the packet a2 (or the RLC PDU a 401). Then, the packet a2 may be sent with the newly added adapt header 402 to the IAB-node1 according to the temporary routing configuration 410 (e.g., through a channel corresponding to the connection ID of UP-Con21).

In an embodiment of FIG. 4, an EndMarker 403 may be further transmitted from the IAB-node2 to the IAB-node1 along with the packet a2. After the IAB-node1 receives the packet a2 with the adapt header 402, the IAB-node1 may remove the adapt header 402 and transmit the packet a2 (e.g., the RLC PUU a 410) to the UE1 according to the temporary routing configuration 420 or the updated routing configuration 220.

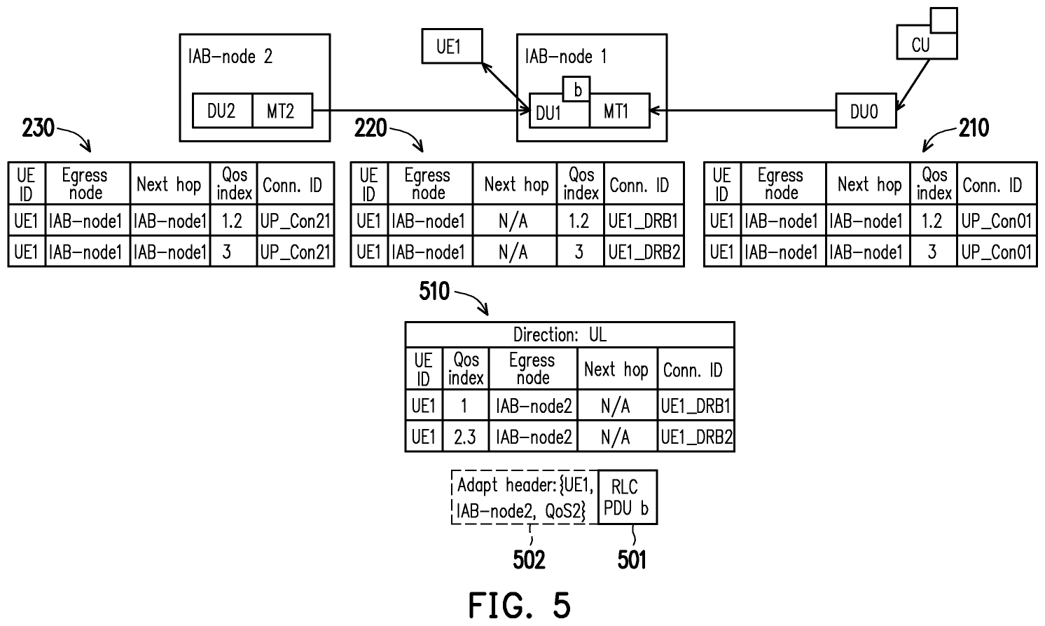

FIG. 5 is a schematic diagram of a packet routing in response to a handover according to an embodiment of the disclosure. It is noted that, FIG. 5 shows an operation for handling the buffered packet without an adapt header reflecting the result of the handover by the target node (i.e., the IAB-node1).

Referring to FIG. 5, it is assumed that a packet b is sent from the IAB-donor CU before the handover occurs. During routing of the packet b, the handover as shown in FIG. 3 occurs. The packet b is unacknowledged and buffered with an adapt header 502 by the IAB-node1. The packet b includes a RLC PDU b 501. However, the adapt header 502 is an old adapt header which is generated before the handover occurs. For example, the adapt header 502 carries information indicating that an egress node of the packet b is the IAB-node2, rather than the IAB-node1.

In an embodiment of FIG. 5, the IAB-donor CU may send instruction or request to the IAB-node1 to configure a temporary routing configuration 510 for downlink in response to the handover. The content of the temporary routing configuration 510 is shown in FIG. 5 as example. The IAB-node1 may obtain the packet b (e.g., the RLC PDU b 501) and the adapt header 502 from the buffer. According to the temporary routing configuration 510, the IAB-node1 may remove the adapt header 502 and transmit the RLC PDU b 501 to the UE1. For example, the IAB-node1 may transmit the RLC PDU b 501 through a channel corresponding to the connection ID of UE1-DRB2 to the UE1 according to the matched entities of {UE1, IAB-node2 and/or QoS} between the adapt header 502 and the temporary routing configuration 510.

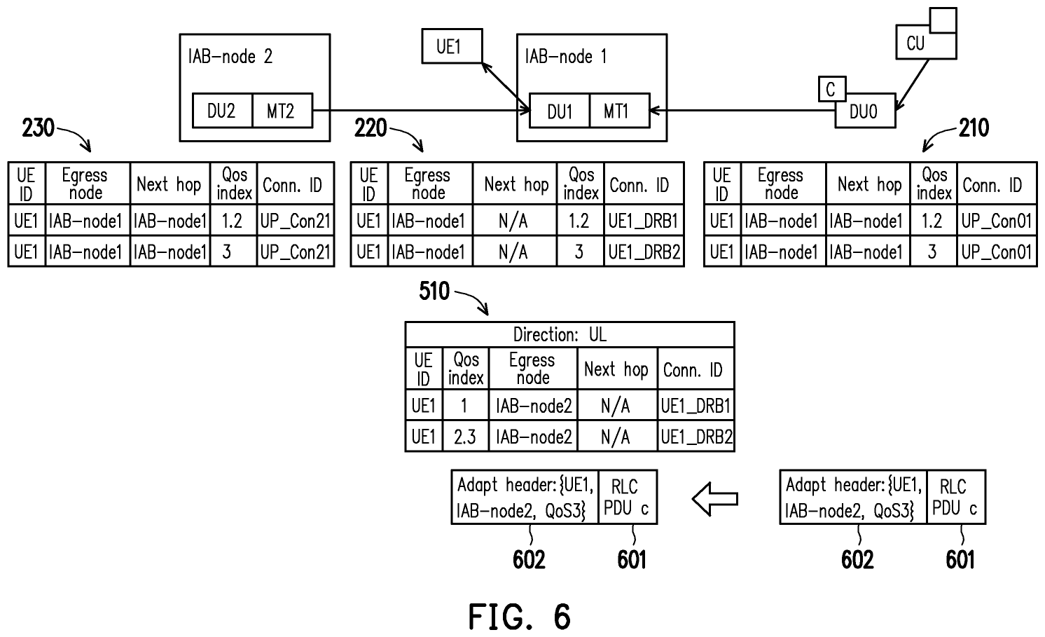

FIG. 6 is a schematic diagram of a packet routing in response to a handover according to an embodiment of the disclosure. It is noted that, FIG. 6 shows an operation for handling the buffered packet without an adapt header reflecting the result of the handover by an intermediate node (i.e., the IAB-donor DU0).

Referring to FIG. 6, it is assumed that a packet c is sent from the IAB-donor CU before the handover occurs. During routing of the packet c, the handover as shown in FIG. 3 occurs. The packet c is unacknowledged and buffered with an adapt header 602 by the IAB-donor DU0. The packet c includes a RLC PDU c 601. Similar to the adapt header 502, the adapt header 602 carries information indicating that an egress node of the packet c is the IAB-node2, rather than the IAB-node1.

It is noted that, in an embodiment of FIG. 6, the IAB-donor CU may not instruct an establishing of a temporary routing configuration in the IAB-donor DU0 in response to the handover. When the packet c is obtained from the buffer and to be routed, the packet c and the adapt header 602 may be transmitted to a next hop (e.g., the IAB-node1) according to the adapt header 602 and the updated (or not updated yet) routing configuration 210. When the IAB-node1 receives the packet c (e.g., the RLC PDU c 601) with the adapt header 602, the IAB-node1 may remove the adapt header 602 and transmit the RLC PDU b 601 to the UE1 according to the temporary routing configuration 510.

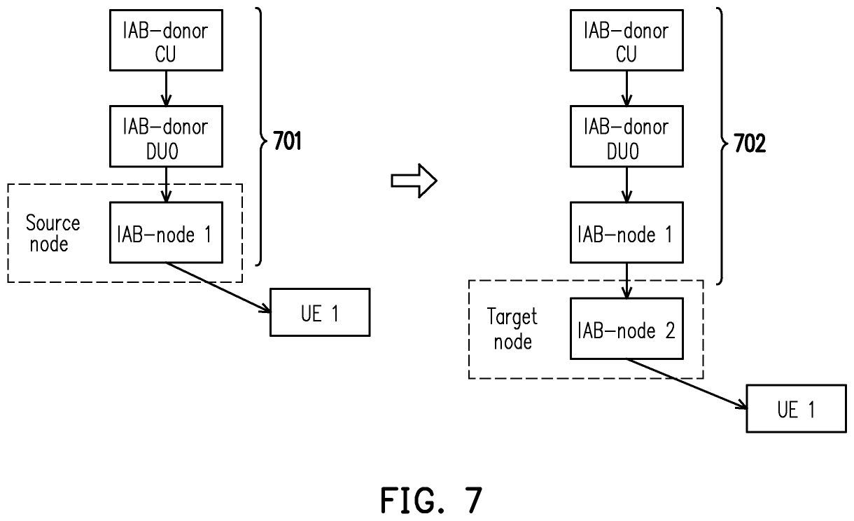

FIG. 7 is a schematic diagram of a handover of a UE from a first node to a second node according to an embodiment of the disclosure. Referring to FIG. 7, in an embodiment, a handover of the UE1 from the source node (e.g., the IAB-node1) to the target node (e.g., the IAB-node2) is occurred. In response to the handover, the connection path between the IAB-donor CU and the UE1 is changed from a connection path 701 to a connection path 702.

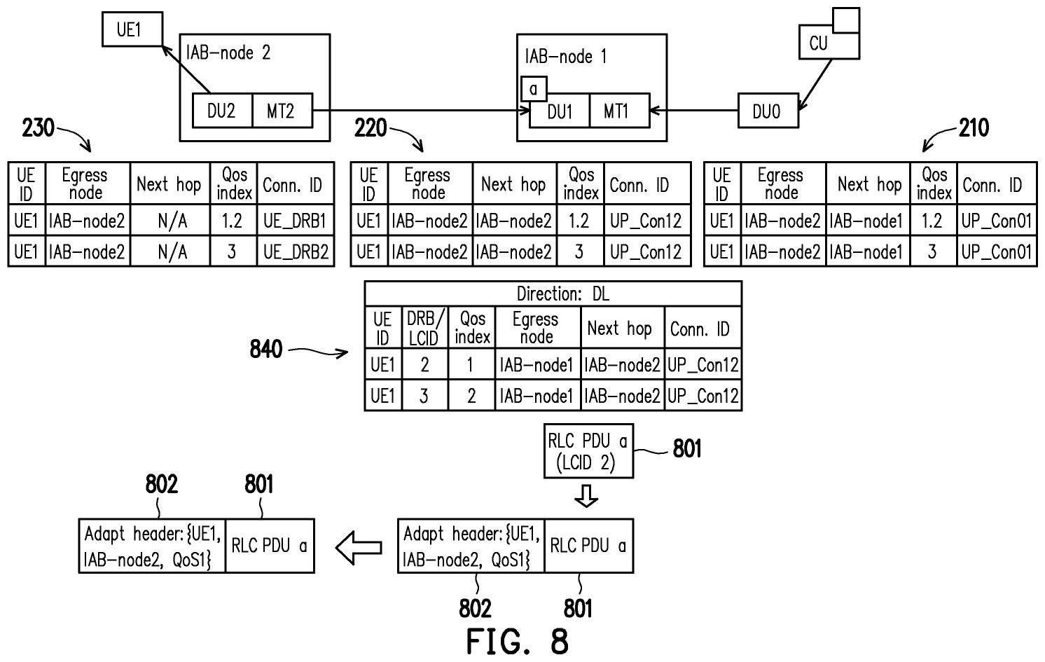

FIG. 8 is a schematic diagram of a packet routing in response to a handover according to an embodiment of the disclosure. Referring to FIG. 8, in response to the handover as shown in FIG. 7, the IAB-donor CU may send requests to the IAB-donor DU0, the IAB-node1 and the IAB-node2 to instruct the updating of the routing configurations 210 to 230, respectively. The content of the updated routing configurations 210 to 230 is shown in FIG. 8 as example. For example, in the updated routing configurations 210 to 230, the egress node is all updated to be the “IAB-node2”, rather than the “IAB-node1” before handover occurs.

In an embodiment of FIG. 8, the IAB-donor CU may sent a request to the IAB-node1 to configure a temporary routing configuration 840 for downlink in the IAB-node1 in response to the handover as shown in FIG. 7. Furthermore, it is assumed that an unacknowledged packet a2 is buffered in the IAB-node1, and the packet a2 is sent from the IAB-donor CU before the handover occurs. For example, the packet a2 may include a RLC PDU a 801. It is noted that, because the IAB-node1 is the previous destination IAB-node of packet a2, the original adapt header of the packet a2 is removed and the RLC PDU a 801 is buffered in the IAB-node1 when the packet a2 arrives IAB-node1.

In an embodiment of FIG. 8, the IAB-node1 may obtained the packet a2 (i.e., the RLC PDU a 801) without an adapt header from at least one buffered and unacknowledged packet and generate a new adapt header 802 for the RLC PDU a 801. For example, the IAB-node1 may generate an adapt header 802 according to the temporary routing configuration 840. For example, the IAB-node1 may obtain a logical channel identity (e.g., LCID 2) of the packet a2 and obtain matched routing information recorded in the temporary routing configuration 840 according to the logical channel identity. The obtained routing information may be added to the adapt header 802 and the adapt header 802 may reflect the result of the handover. The adapt header 802 may carry information as shown in FIG. 8 (e.g., UE1, IAB-node2 and QoS1) as example. Then, the adapt header 802 may be packaged onto the packet a2 (or the RLC PDU a 801). Then, the packet a2 may be sent with the newly added adapt header 802 to the IAB-node2 according to the temporary routing configuration 840 (e.g., through a channel corresponding to the connection ID of UP-Con12). When the IAB-node2 receives the packet a2 (e.g., the RLC PDU a 801) with the adapt header 802, the IAB-node2 may remove the adapt header 802 and transmit the RLC PDU a 801 to the UE1 according to the updated routing configuration 230.

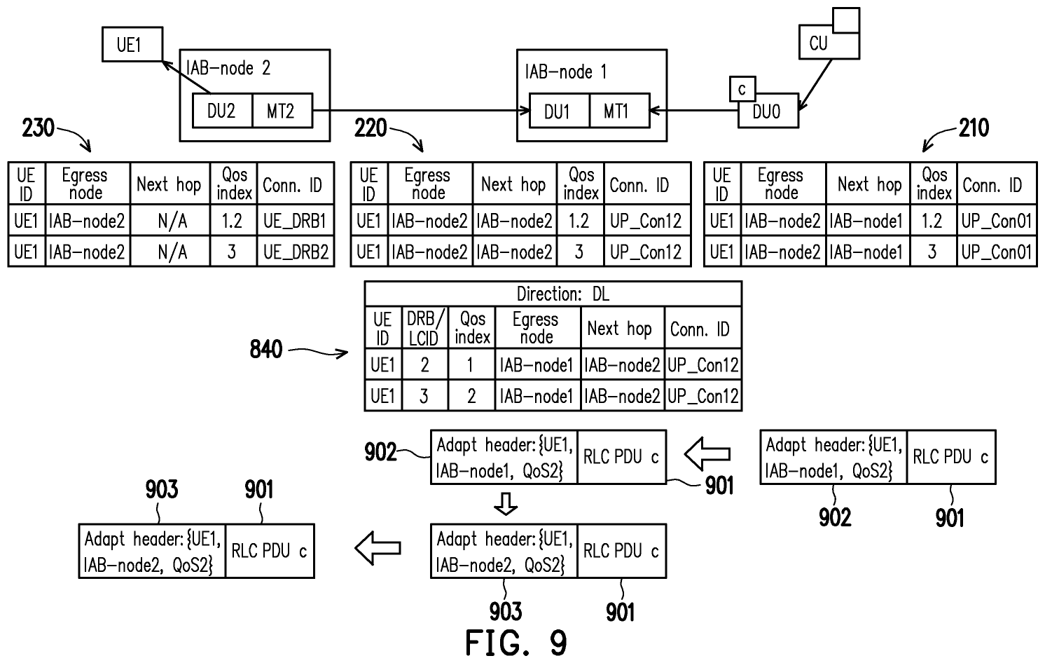

FIG. 9 is a schematic diagram of a packet routing in response to a handover according to an embodiment of the disclosure. It is noted that, FIG. 9 shows an operation for handling the buffered packet without an adapt header reflecting the result of the handover by an intermediate node (i.e., the IAB-donor DU0).

Referring to FIG. 9, it is assumed that a packet c is sent from the IAB-donor CU before the handover occurs. During routing of the packet c, the handover as shown in FIG. 7 occurs. The packet c is unacknowledged and buffered with an adapt header 902 by the IAB-donor DU0. The packet c includes a RLC PDU c 901. The adapt header 902 carries information indicating that an egress node of the packet c is the IAB-node1, rather than the IAB-node2.

It is noted that, in an embodiment of FIG. 9, the IAB-donor CU may not instruct an establishing of a temporary routing configuration in the IAB-donor DU0 in response to the handover. When the packet c is obtained from the buffer and to be routed, the packet c and the adapt header 902 may be transmitted to a next hop (e.g., the IAB-node1) according to the adapt header 902 and the updated (or not updated yet) routing configuration 210.

When the IAB-node1 receives the packet c (e.g., the RLC PDU c 901) with the adapt header 902, the IAB-node1 may modify the adapt header 902 and generate a new adapt header 903 according to the temporary routing configuration 840. For example, the egress node of the packet c indicated by the adapt header 902 may be changed to be the IAB-node2 from the IAB-node1. Then, the packet c (e.g., the RLC PDU c 901) may be transmitted to the IAB-node2 with the adapt header 903. When the IAB-node2 receives the packet c with the adapt header 903, the IAB-node2 may remove the adapt header 903 and transmit the packet c (e.g., the RLC PDU c 901) to the UE1 according to the updated routing configuration 230 (e.g., through a channel corresponding to the connection ID of UR_DRB1).

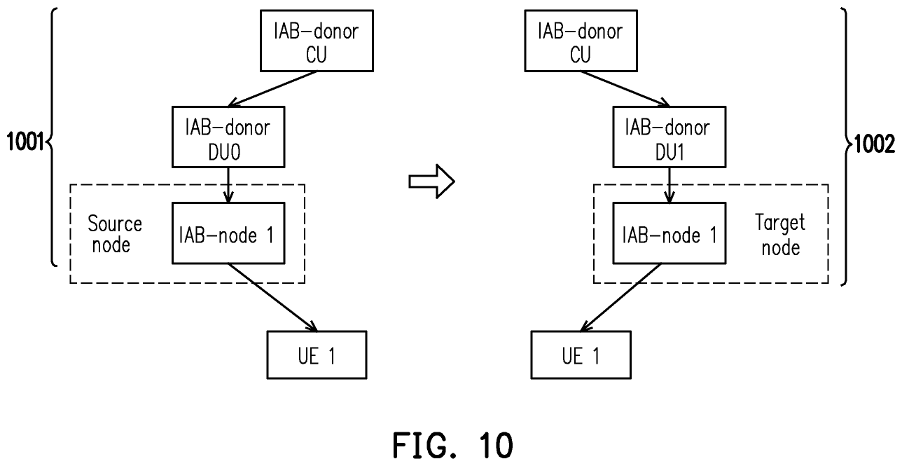

FIG. 10 is a schematic diagram of a handover of a UE from a first node to a second node according to an embodiment of the disclosure. Referring to FIG. 10, in an embodiment, a handover of the UE1 from the source node (e.g., the IAB-node1) to the target node (e.g., the IAB-node2) is occurred. In response to the handover, the connection path between the IAB-donor CU and the UE1 is changed from a connection path 1001 to a connection path 1002.

In an embodiment of FIG. 10, the IAB-donor CU may sent requests to the IAB-donor DU0, the IAB-node1 and the IAB-node2 to update the routing configurations 210 to 230, respectively, in response to the handover. Furthermore, the IAB-donor CU may sent requests to the IAB-node1 and/or the IAB-node2 to establish temporary routing configuration in the IAB-node1 and/or the IAB-node2 for routing the packet being buffered and sent before the handover occurs. The detail of packet routing based on the routing configuration and/or the temporary routing configuration is described above and not repeated hereinafter.

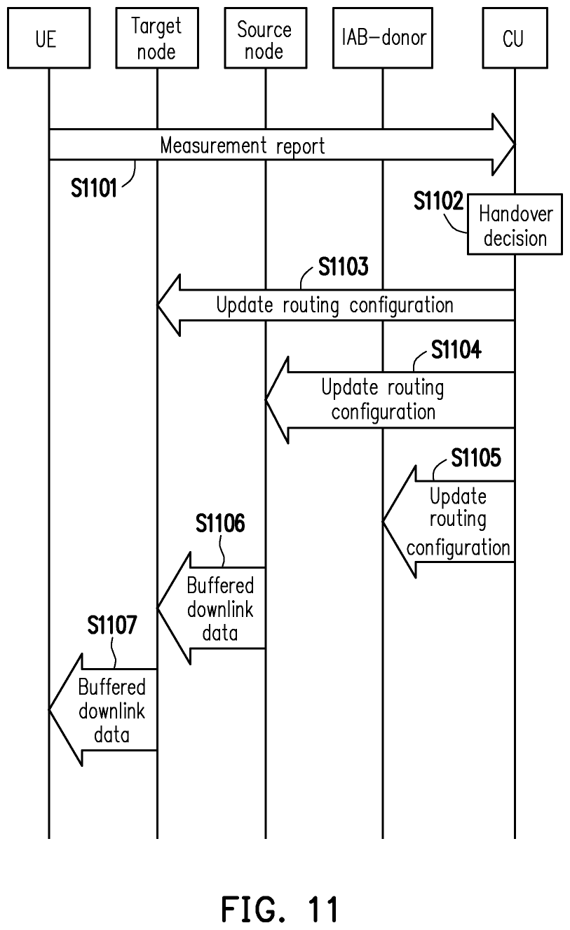

FIG. 11 is a communication time flow according to an embodiment of the disclosure. Referring to FIG. 11, in step 1101, the UE transmits the measurement report to the IAB-donor CU through at least one of an IAB-node served as the target node, an IAB-node served as the source node and an IAB-donor. In step 1102, the IAB-donor CU determine to perform a handover of the UE from the source node to the target node. In steps 1103 to 1105, the IAB-donor CU sends requests to the target node, the source node and the IAB-donor to update the routing configuration in the target node, the source node and the IAB-donor, respectively. Furthermore, in steps 1103 and 1104, the IAB-donor CU may also send requests to the target node and the source node to establish the temporary routing configuration, respectively. In step 1106, the buffered downlink data packet may be transmitted from the source node to the target node according to the temporary routing configuration and/or the updated routing configuration. Then, in step S1107, the buffered downlink data packet may be further transmitted to the UE according to the temporary routing configuration and/or the updated routing configuration.

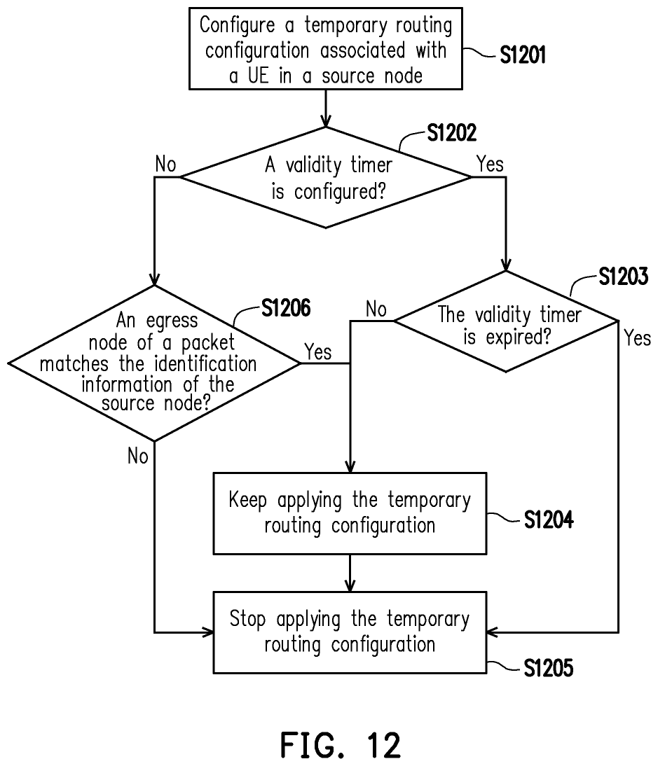

FIG. 12 is a flowchart of a packet routing method according to an embodiment of the disclosure. It is noted that, the flow chart of FIG. 12 is executed by a source node after a handover for checking whether a temporary routing configuration in this source node is valid (or invalid). If a temporary routing configuration is determined as invalid, then this temporary routing configuration would not be applied to route data packet anymore. Otherwise, the valid temporary routing configuration can still be used for routing data packet.

Referring to FIG. 12, in step 1201, a temporary routing configuration associated with a UE is configured in a source node. In step 1202, it is determined whether a validity timer associated to the temporary routing configuration is configured. If the validity timer associated to the temporary routing configuration is configured, in step 1203, it is determined whether the validity timer is expired. If the validity timer is not expired, in step 1204, the temporary routing configuration is treated as still valid in the source node. For example, the valid temporary routing configuration may be kept applied for routing data packet. If the validity timer is expired, in step 1205, it is determined to stop applying the temporary routing configuration and treated as no valid temporary routing configuration in the source node. Furthermore, in an embodiment, the temporary routing configuration may be released in step 1205.

If the validity timer associated to the temporary routing configuration is not configured, in step 1206, it is determined whether an egress node of a packet matches the identification information of the source node. The identification information of the source node maybe an ID or an address of the source node. If the egress node of this packet matches the identification information of the source node, in step S1204, the temporary routing configuration is treated as still valid in the source node. Otherwise, if the egress node of this packet does not match the identification information of the source node, in step S1205, it is determined to stop applying the temporary routing configuration and treated as no valid temporary routing configuration in the source node.

In an embodiment of the disclosure, the procedure executed by a source node after a handover for checking whether a temporary routing configuration in the source node is valid (or invalid) includes the source node determining a temporary routing configuration to be valid upon receiving the temporary routing configuration, and determining the temporary routing configuration to be invalid upon receiving a notification to release the temporary routing configuration or to stop the applying of the temporary routing configuration.

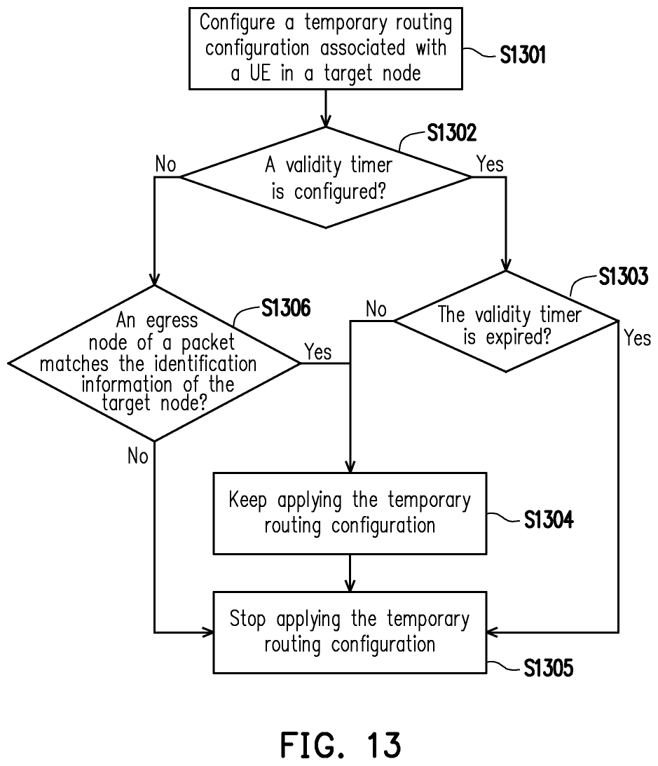

FIG. 13 is a flowchart of a packet routing method according to an embodiment of the disclosure. It is noted that, the flow chart of FIG. 13 is executed by a target node for checking whether a temporary routing configuration in this target node is valid (or invalid).

Referring to FIG. 13, in step 1301, a temporary routing configuration associated with a UE is configured in a target node. In step 1302, it is determined whether a validity timer associated to the temporary routing configuration is configured. If the validity timer associated to the temporary routing configuration is configured, in step 1303, it is determined whether the validity timer is expired. If the validity timer is not expired, in step 1304, the temporary routing configuration is treated as still valid in the target node and may be kept applied for routing data packet. If the validity timer is expired, in step 1305, it is determined to stop applying the temporary routing configuration and treated as no valid temporary routing configuration in the target node. Furthermore, in an embodiment, the temporary routing configuration may be released in step 1305.

If the validity timer associated to the temporary routing configuration is not configured, in step 1306, it is determined whether an egress node of a packet matches the identification information of the target node. The identification information of the target node maybe an ID or an address of the target node. If the egress node of this packet matches the identification information of the target node, in step S1305, it is determined to stop applying the temporary routing configuration and treated as no valid temporary routing configuration in the target node. Otherwise, if the egress node of this packet does not match the identification information of the target node, in step S1304, the temporary routing configuration is treated as still valid in the target node.

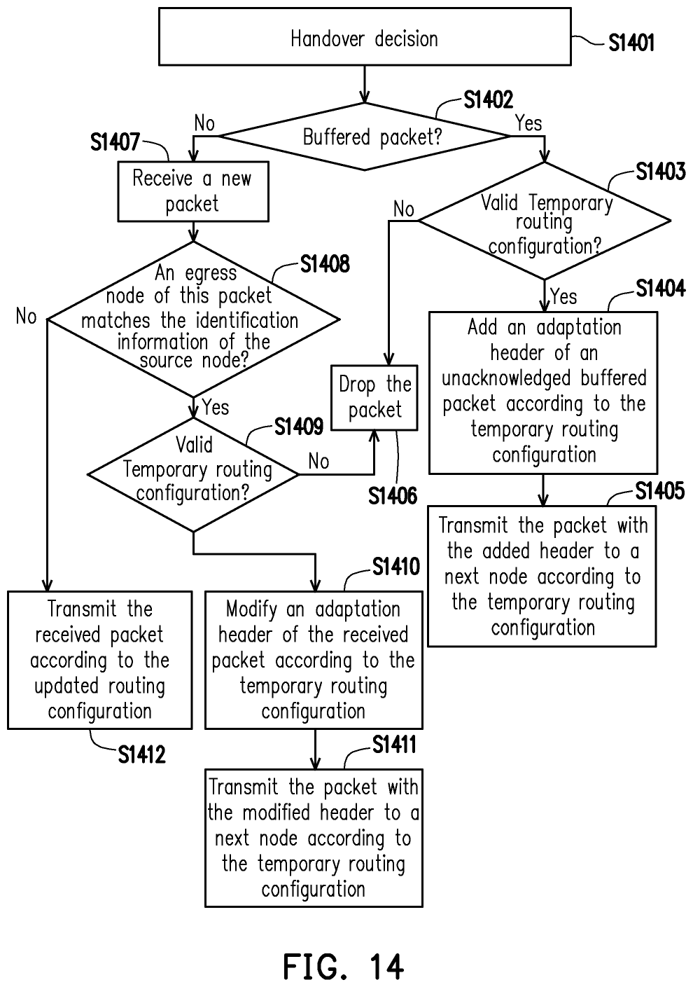

FIG. 14 is a flowchart of a packet routing method according to an embodiment of the disclosure. It is noted that, the flow chart of FIG. 14 is executed by a source node for routing data packet. Referring to FIG. 14, in step 1401, a handover of a UE from the source node to a target node occurs. In step 1402, it is determined whether there is at least one buffered packet in the source node. If there is at least one buffered packet in the source node, in step 1403, it is determined whether a valid temporary routing configuration exists. If the valid temporary routing configuration exists, in step 1404, an unacknowledged packet is retrieved from the buffer of the source node and an adaptation header (or an adapt header) is added to the unacknowledged packet according to the temporary routing configuration. In step 1405, the packet is transmitted to a next hop according to the temporary routing configuration and the packet may be acknowledged. If the valid temporary routing configuration does not exist, in step 1406, the buffered packet is dropped and may be treated as acknowledged.

If there is no buffered packet in the source node, in step 1407, a new packet is received. In step 1408, it is determined whether an egress node of this packet matches the identification information of this source node. If the egress node of this packet matches the identification information of this source node, in step 1409, it is determined whether a valid temporary routing configuration exists. If the valid temporary routing configuration exists, in step 1410, an adaptation header of the received packet is modified according to the valid temporary routing configuration. In step 1411, the packet is transmitted with the modified header to a next hop according to the valid temporary routing configuration. If the valid temporary routing configuration does not exist, in step 1406, the packet is dropped and may be handled as acknowledged.

If the egress node of this packet does not match the identification information of this source node, in step 1412, the packet may be routed according to the updated routing configuration and a temporary routing configuration may be treated as invalid and/or be removed if this temporary routing configuration exists. Furthermore, in an embodiment, in step 1412, an Endmarker may be generated and sent to the target node.

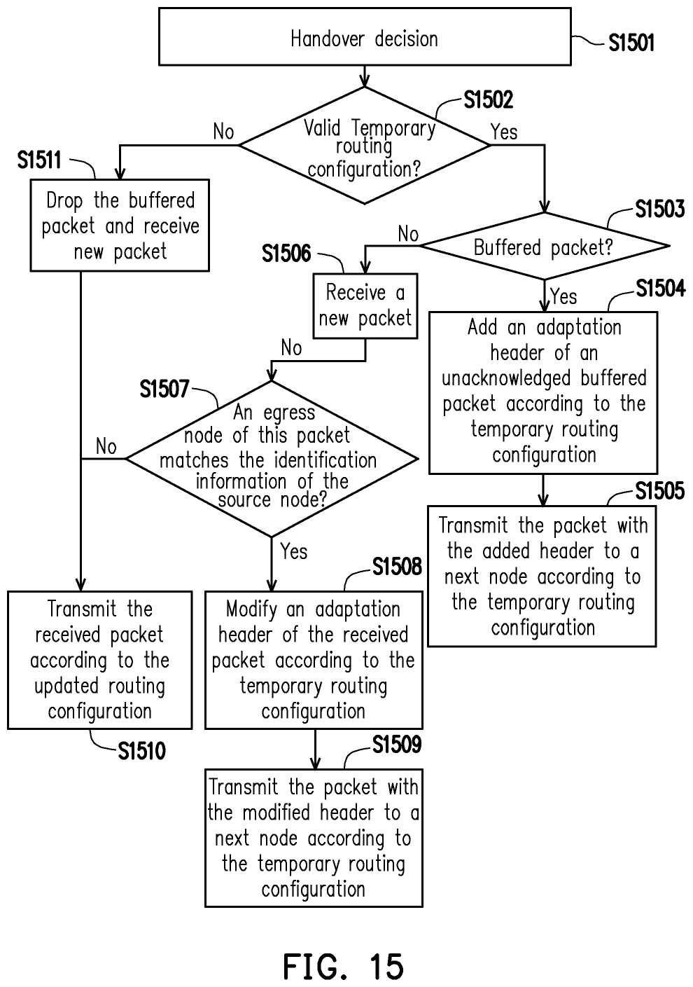

FIG. 15 is a flowchart of a packet routing method according to an embodiment of the disclosure. It is noted that, the flow chart of FIG. 15 is executed by a source node for routing data packet. Referring to FIG. 15, in step 1501, a handover of a UE from the source node to a target node occurs. In step 1502, it is determined whether a valid temporary routing configuration exists. If the valid temporary routing configuration exists, in step 1503, it is determined whether there is at least one buffered packet in the source node. If there is at least one buffered packet in the source node, in step 1504, an unacknowledged packet is retrieved from the buffer of the source node and an adaptation header (or an adapt header) is added to the unacknowledged packet according to the temporary routing configuration. In step 1505, the packet is transmitted to a next hop according to the temporary routing configuration and the packet may be handled as acknowledged.

If there is no buffered packet in the source node, in step 1506, a new packet is received. In step 1507, it is determined whether an egress node of this packet matches the identification information of this source node. If the egress node of this packet matches the identification information of this source node, in step 1508, an adaptation header of the received packet is modified according to the valid temporary routing configuration. In step 1509, the packet is transmitted with the modified header to a next hop according to the valid temporary routing configuration. If the egress node of this packet does not match the identification information of this source node, in step 1510, the packet may be routed according to the updated routing configuration, and the valid temporary routing configuration may be treated as invalid and/or be removed. Furthermore, in an embodiment, in step 1510, an Endmarker may be generated and sent to the target node.

If the valid temporary routing configuration does not exist, in step 1511, the packet is dropped and may be treated as acknowledged. After the routing configuration is updated in response to the handover, newly received may be routed according to the updated routing configuration in step 1510.

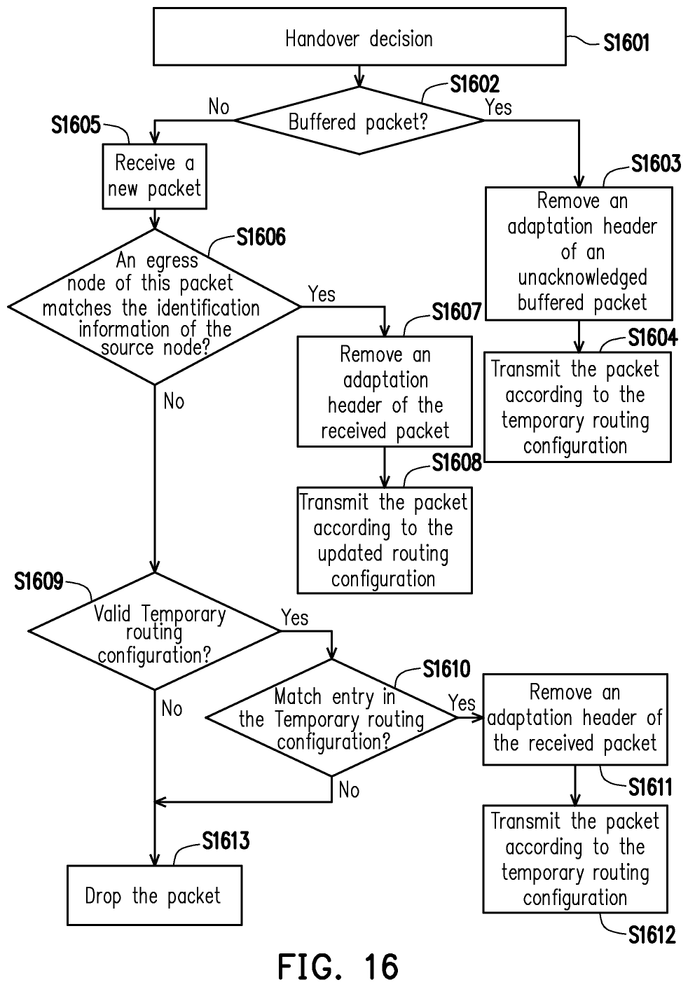

FIG. 16 is a flowchart of a packet routing method according to an embodiment of the disclosure. It is noted that, the flow chart of FIG. 16 is executed by a target node for routing data packet. Referring to FIG. 16, in step 1601, a handover of a UE from a source node to the target node occurs. In step 1602, it is determined whether there is at least one buffered packet in the target node. If there is at least one buffered packet in the target node, in step 1603, an unacknowledged packet is retrieved from the buffer of the target node and an adaptation header (or an adapt header) of the unacknowledged packet is removed. In step S1604, the packet is transmitted to the UE according to a temporary routing configuration in the target node and may be treated as acknowledged.

If there is no buffered packet in the target node, in step 1605, a new packet is received. In step 1606, it is determined whether an egress node of this packet matches the identification information of this target node. If the egress node of this packet matches the identification information of this target node, in step 1607, an adaptation header of the packet is removed. In step S1608, the packet is transmitted to the UE according to an updated routing configuration in the target node and may be treated as acknowledged. In an embodiment, in step 1607, a temporary routing configuration associated with the UE may be stopped applied for packet routing and be treated as invalid and/or be removed if this temporary routing configuration exists in the target node.

If the egress node of this packet does not match the identification information of this target node, in step 1609, it is determined whether a valid temporary routing configuration exists in the target node. If the valid temporary routing configuration exists in the target node, in step S1610, it is determined whether at least one entry in an adaption header of this packet matches with entries in the valid temporary routing configuration. If the at least one entry in the adaption header of this packet matches with the entries in the valid temporary routing configuration, in step S1611, the adaption header of this packet is removed. In step 1612, the packet is transmitted to the UE according to the valid temporary routing configuration and may be treated as acknowledged. If there is no entry in the adaption header of this packet matches with the entries in the valid temporary routing configuration, in step S1613, this packet may be dropped. Furthermore, if it is determined that no valid temporary routing configuration exists in the target node in step 1609, then step S1613 is also entered.

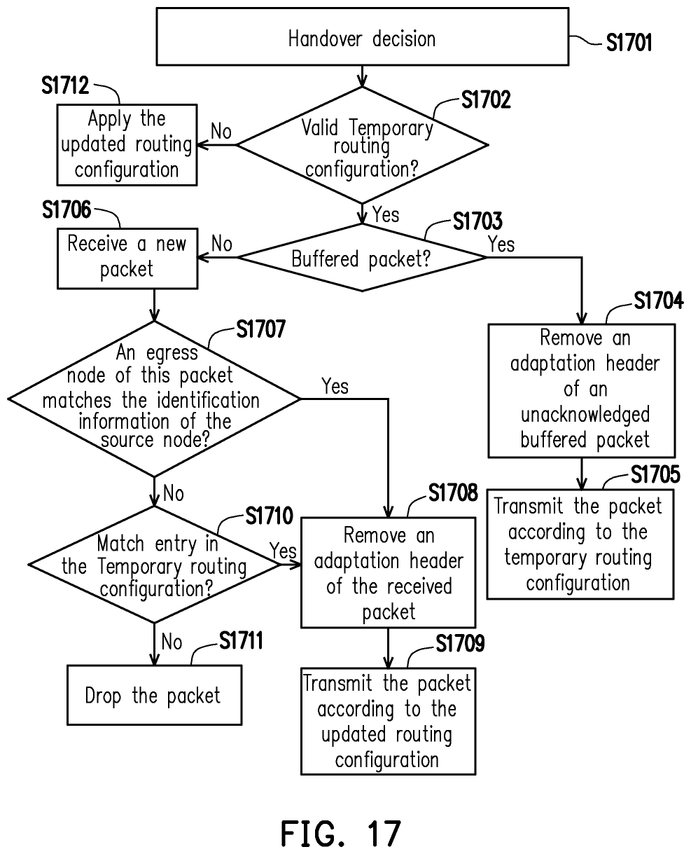

FIG. 17 is a flowchart of a packet routing method according to an embodiment of the disclosure. It is noted that, the flow chart of FIG. 17 is executed by a target node for routing data packet. Referring to FIG. 17, in step 1701, a handover of a UE from a source node to the target node occurs. In step 1702, it is determined whether a valid temporary routing configuration exists in the target node. If the valid temporary routing configuration exists in the target node, in step 1703, it is determined whether there is at least one buffered packet in the target node. If there is at least one buffered packet in the target node, in step 1704, an unacknowledged packet is retrieved from the buffer of the target node and an adaptation header (or an adapt header) of the unacknowledged packet is removed. In step S1705, the packet is transmitted to the UE according to the temporary routing configuration in the target node and may be treated as acknowledged.

If there is no buffered packet in the target node, in step 1706, a new packet is received. In step 1707, it is determined whether an egress node of this packet matches the identification information of this target node. If the egress node of this packet matches the identification information of this target node, in step 1708, an adaptation header of the packet is removed. In step S1709, the packet is transmitted to the UE according to an updated routing configuration in the target node and may be treated as acknowledged. In an embodiment, in step 1708, the temporary routing configuration associated with the UE may be stopped applied for packet routing and be treated as invalid and/or be removed.

If the egress node of this packet does not match the identification information of this target node, in step 1710, it is determined whether at least one entry in an adaption header of this packet matches with entries in the valid temporary routing configuration. If the at least one entry in the adaption header of this packet matches with the entries in the valid temporary routing configuration, go to the steps S1708 and S1709. If there is no entry in the adaption header of this packet matches with the entries in the valid temporary routing configuration, in step S1711, this packet may be dropped and acknowledged. Furthermore, if it is determined that no valid temporary routing configuration exists in the target node in step 1702, an updated routing configuration may be applied for routing newly arrived packet after the routing configuration is updated.

It is noted that, for an intermediate node (e.g., the IAB-donor DU0), the intermediate node may transmit a packet based on a routing information which is not updated in response to a handover or based on a routing information which is already updated in response to the handover. The intermediate node can successfully transmit the packet to a next hop without using the temporary routing configuration after the handover occurs.

However, each of the steps of FIGS. 11 to 17 has been described in detail in the aforementioned description, so that details thereof are not repeated. It should be noted that each of the steps of FIGS. 11 to 17 may be implemented as a plurality of program codes or circuits, which is not limited by the invention. Moreover, the method of FIGS. 11 to 17 may be used in collaboration with the aforementioned embodiments, or may be used independently, which is not limited by the invention. It is noted that, in the embodiments above, each node and/or the UE may at least include a transceiver, a storage circuit and a processor for performing the related operations. Other hardware circuits can also be applied to the nodes and/or the UE to provide additional functions.

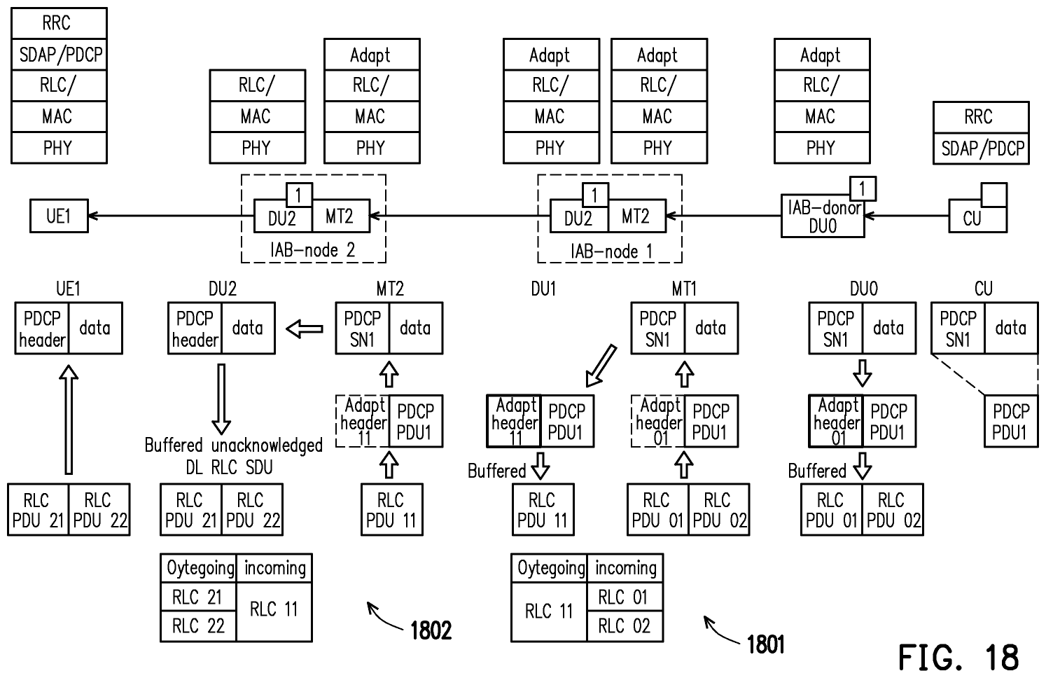

FIG. 18 is a schematic diagram of a packet routing with a delayed RLC ack according to an embodiment of the disclosure. Referring to FIG. 18, a packet 1 (e.g., a PDCP PDU 1) is buffered by the IAB-donor CU, and the IAB-donor CU instructs the IAB-donor DU0 to transmit the packet 1. The IAB-donor DU0 adds an adapt header 01 to the packet 1 and divides the PDCP PDU 1 to be RLC PDU 01 and RLC PDU 02. The RLC PDU 01 and RLC PDU 02 may be buffered by the IAB-donor DU0 and be transmitted to the IAB-node1 one by one.

When the IAB-node1 receives the RLC PDU 01 and RLC PDU 02, the IAB-node1 may recover the packet 1 (e.g., the PDCP PDU 1) and replace the adapt header 01 with an adapt header 11. Then, the IAB-node1 may buffer a RLC PDU 11 from the PDCP PDU 1 and transmit the PDCP PDU1 with the adapt header 11 to the IAB-node2. When the IAB-node2 receives the PDCP PDU1 with the adapt header 11, the IAB-node2 may generate and buffer RLC PDU 21 and RLC PDU 22. Then, the IAB-node2 may remove the adapt header 11 and transmit the RLC PDU 21 and RLC PDU 22 to the UE 1.

It is noted that, the IAB-node1 may further maintain a mapping relationship between an identity of at least one received and unacknowledged packets (e.g., the RLC PDU 01 and RLC PDU 02) and an identity of at least one sent packets (e.g., the RLC PDU 11) in a mapping table 1801. The IAB-node2 may further also maintain a mapping relationship between an identity of at least one received and unacknowledged packets (e.g., the RLC PDU 11) and an identity of at least one sent packets (e.g., the RLC PDU 21 and the RLC PDU 22) in a mapping table 1802.

When the RLC PDU 21 and the RLC PDU 22 is sent to the UE1, the IAB-node2 may acknowledge the IAB-node1 according to the mapping table 1802. For example, the IAB-node2 may acknowledge the IAB-node1 that the transmission of the buffered RLC PDU 11 is finished. Then, the IAB-node1 may acknowledge the IAB-donor DU0 according to the mapping table 1801. For example, the IAB-node1 may acknowledge the IAB-donor DU0 that the transmission of the buffered RLC PDU 01 and the RLC PDU 02 is finished. It is noted that, the delayed RLC ack mechanism of FIG. 18 may also be performed with the handover handling described in the above embodiments, which is not repeated hereinafter.

On the basis above, a packet routing in an IAB network (or an IAB topology) can be normally executed no matter whether a handover of a UE from a first node (i.e., a source node) to a second node (i.e., a target node) is occurs. Furthermore, a delayed RLC ack mechanism may also be applied to the packet routing in the IAB network.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A packet routing method for at least one node in a communication system, comprising:
updating, by a control node, a first routing configuration configured to a source node and a second routing configuration configured to a target node in response to a mobility of a user equipment (UE) from the source node to the target node;
receiving, by at least one of the source node and the target node, a first packet with a first header reflecting a result of the mobility; and
transmitting, by the at least one of the source node and the target node, the first packet with the first header according to at least one of the updated first routing configuration and the updated second routing configuration.

2. The packet routing method according to claim 1, further comprising:
configuring, by the control node, an adaptive routing configuration to at least one of the source node and the target node in response to the mobility;
obtaining, by the at least one of the source node and the target node, a second packet without the first header reflecting the result of the mobility; and
transmitting, by the at least one of the source node and the target node, the second packet according to the adaptive routing configuration.

3. The packet routing method according to claim 2, wherein transmitting the second packet according to the adaptive routing configuration comprises:
adding a second header reflecting the result of the mobility to the second packet according to the adaptive routing configuration; and
transmitting the second packet according to the adaptive routing configuration.

4. The packet routing method according to claim 1, wherein information carried by the first header comprises identification information of an egress node being the target node and an identification information of a routing path associated with the first packet.

5. The packet routing method according to claim 4, wherein the identification information of the routing path associated with the first packet associates QoS information of the first packet.

6. The packet routing method according to claim 4, wherein the information carried by the first header further comprises identification information of the UE.

7. The packet routing method according to claim 1, wherein information recorded in at least one of the first routing configuration and the second routing configuration comprises identification information of an egress node, identification information of a routing path associated with the first packet, and identification information of an egress backhaul Radio Link Control (RLC) channel.

8. The packet routing method according to claim 7, wherein the information recorded in the at least one of the first routing configuration and the second routing configuration further comprises QoS/priority information.

9. The packet routing method according to claim 7, wherein the information recorded in the at least one of the first routing configuration and the second routing configuration further comprises identification information of an ingress backhaul RLC channel.

10. The packet routing method according to claim 7, wherein the information recorded in the at least one of the first routing configuration and the second routing configuration further comprises identification information of the UE and identification information of a next hop.

11. The packet routing method according to claim 2, further comprising:
receiving, by the source node, a third packet with a third header by the source node before receiving the routing information configuration in response to the mobility of a UE from source node to the target node;
transmitting, by the source node, the third packet according to the adaptive routing configuration after receiving the routing information configuration in response to the mobility of the UE from source node to the target node if the third header indicates that an egress node of the third packet is the source node

12. The packet routing method according to claim 11, wherein transmitting the third packet according to the adaptive routing configuration comprises:
modifying, by the source node, the third header according to the adaptive routing configuration; and
transmitting, by the source node, the third packet with the modified third header according to the adaptive routing configuration.

13. The packet routing method according to claim 11, further comprising:
transmitting, by the source node, the third packet according to the updated routing configuration if the third header indicates that the egress node of the third packet is not the source node.

14. The packet routing method according to claim 11, further comprising:
transmitting an EndMarker from the source node to the target node if the third header indicates that the egress node of the third packet is not the source node.

15. The packet routing method according to claim 2, further comprising:
receiving a fourth packet by the target node after receiving the routing information configuration in response to the mobility of the UE from source node to the target node; and
removing, by the target node, a fourth header from the fourth packet and transmitting the fourth packet according to the updated second routing configuration if the fourth header indicates that an egress node of the fourth packet is the target node.

16. The packet routing method according to claim 15, further comprising:
stopping applying the adaptive routing configuration in the target node if the fourth header indicates that the egress node of the fourth packet is the target node.

17. The packet routing method according to claim 15, further comprising:
removing the fourth header from the fourth packet and transmitting the fourth packet according to the adaptive routing configuration if the fourth header indicates that the egress node of the fourth packet is not the target node.

18. The packet routing method according to claim 2, further comprising:
determining the adaptive routing configuration as invalid if a timer associated with the adaptive routing configuration is expired.

19. The packet routing method according to claim 2, further comprising:
determining the adaptive routing configuration as invalid if a notification is received to stop the applying of the adaptive routing configuration.

20. The packet routing method according to claim 1, further comprising:
establishing an association between an identity of at least one received and unacknowledged packet and an identity of at least one sent packet if a PDU, packet data unit, of the at least one sent packet are used for transmitting the SDU, service data unit, of the at least one received packet; and
removing the association between the at least one received and unacknowledged packet and the at least one sent packet after all the at least one sent packet associated with the at least one received packet are acknowledged and the at least one received and unacknowledged packet is acknowledged.

21. The packet routing method according to claim 1, further comprising:
providing an instruction for updating the first routing configuration and the second routing configuration by the control node.

22. The packet routing method according to claim 1, wherein the mobility is controlled by the control node.

23. The packet routing method according to claim 1, wherein each of the source node and the target node is an IAB-node.

24. A communication system, comprising:
a UE;
a source node;
a target node; and
a control node, coupled to the source node and the target node,
wherein the control node is configured to update a first routing configuration configured to the source node and a second routing configuration configured to the target node in response to a mobility of a UE from the source node to the target node,
at least one of the source node and the target node is configured to receive a first packet with a first header reflecting a result of the mobility, and
the at least one of the source node and the target node is further configured to transmit the first packet with the first header according to at least one of the updated first routing configuration and the updated second routing configuration.
